(19) United States
(12) Patent Application Publication
(10) Pub. No.: US 2006/0046768 A1
(43) Pub. Date: Mar. 2, 2006

(54) Mobile phone address book population device and technique

(76) Inventor: Bilhan Kirbas, San Diego, CA (US)

Correspondence Address: KYOCERA WIRELESS CORP., P.O. BOX 928289, SAN DIEGO, CA, 92192-8289, US

(21) Appl. No.: 10/929,171

(22) Filed: Aug. 30, 2004

(51) Int. Cl. H04M 1/00

(52) U.S. Cl. 455/550.1

(57) ABSTRACT

An exemplary mobile phone includes a display, an input key, a processor coupled to the display and to the input key, and a memory coupled to the processor. The memory is capable of storing a data collection structure, such as an electronic address book, and the data collection structure is capable of storing a number of entries, where each entry is associated with corresponding contact information. The mobile phone further includes a manager module executed by the processor. The manager module is configured to receive address book data transmitted over a wireless data communication link. According to various embodiments, at least one field of the entries is capable of being dynamically modified based on the received address book data.

### FIELD OF THE INVENTION

The present invention relates to the field of wireless communication devices. More specifically, the invention relates to address book management for wireless communication devices.

### BACKGROUND OF THE INVENTION

Wireless communication devices, such as mobile phones, typically store contact information in an electronic address book stored in an internal memory. Each entry of the address book may be capable of storing a contact's name, address, phone number, fax number, and email address, for example. Thus, a mobile phone user is able to conveniently initiate a call by accessing the phone book, and selecting the particular contact the user wishes to call, without having to memorize the particular contact's information.

In general, each address book entry must be manually entered and maintained by the user. In some cases, the address entries can be synchronized with another address book, resident on another device such as a computer via a link cable. In any case, the accuracy of each address book entry must be maintained by the user. Thus, outdated address book entries must be deleted and/or updated manually by the user. The problem of outdated address book data is particularly problematic for business contacts with whom a user has limited or sporadic dealings.

Moreover, the ability for business contacts to reach their customers with promotions over a mobile phone is currently severely limited. Conventional techniques typically involve either direct voice telemarketing and/or advertising products and services to mobile phone users via unsolicited commercial SMS messages (SPAM), both techniques of which have limited or otherwise negative customer appeal. Customer dissatisfaction is further aggravated in cases where a recipient is charged for receiving the unsolicited SMS message.

Accordingly, there is a strong need in the art for addressing these and other shortcomings associated with known mobile phone address books.

### SUMMARY OF THE INVENTION

A dynamic mobile phone address book population device and technique is disclosed. In one embodiment, a mobile phone includes a display, an input key, a processor coupled to the display and to the input key, and a memory coupled to the processor. The memory is capable of storing a data collection structure, such as an electronic address book, and the data collection structure is capable of storing a number of entries, where each entry is associated with corresponding contact information. The mobile phone further includes a manager module executed by the processor. The manager module is configured to receive address book data transmitted over a wireless data communication link. According to various embodiments, at least one field of the entries is capable of being dynamically modified based on the received address book data, as discussed below.

According to one embodiment, the manager module receives the address book data based on the geographic location of the mobile phone. For example, the address book data may be based on the geographic location to which the mobile phone is travelling or from which the mobile phone is leaving.

According to one embodiment, at least one of the phone book entries is a public-type entry. As discussed below, a public entry type may be a contact that is publicly available, such as a listing from a public telephone book, for example. According to this particular embodiment, the public-type entry may be added to the data collection structure based on the geographic location of the mobile phone, or may be deleted from the data collection structure based on the geographic location of the mobile phone.

According to one embodiment, one or more of the phone book entries may be capable of being associated with a commercial promotion. For example, the address book data may include a commercial promotion, such as a coupon, which is then associated with an entry in the mobile phone address book.

The present invention also relates to machine readable media on which are stored embodiments of the present invention. It is contemplated that any media suitable for storing instructions is within the scope of the present invention. By way of example, such media may take the form of magnetic, optical, or semiconductor media. The invention also relates to data structures that contain embodiments of the present invention, and to the transmission of data structures containing embodiments of the present invention.

Other features and advantages of the present invention will become more readily apparent to those of ordinary skill in the art after reviewing the following detailed description and accompanying drawings.

### BRIEF DESCRIPTION OF THE DRAWINGS

FIG. 1 illustrates an exemplary system arrangement according to one embodiment of the invention.

FIG. 2 illustrates a block diagram of an exemplary mobile phone according to one embodiment of the invention.

FIG. 3 illustrates a system environment according to one embodiment of the invention.

FIG. 4 is a flow chart depicting a method for dynamically populating and/or modifying a mobile phone address book according to one embodiment of the invention.

### DETAILED DESCRIPTION OF THE INVENTION

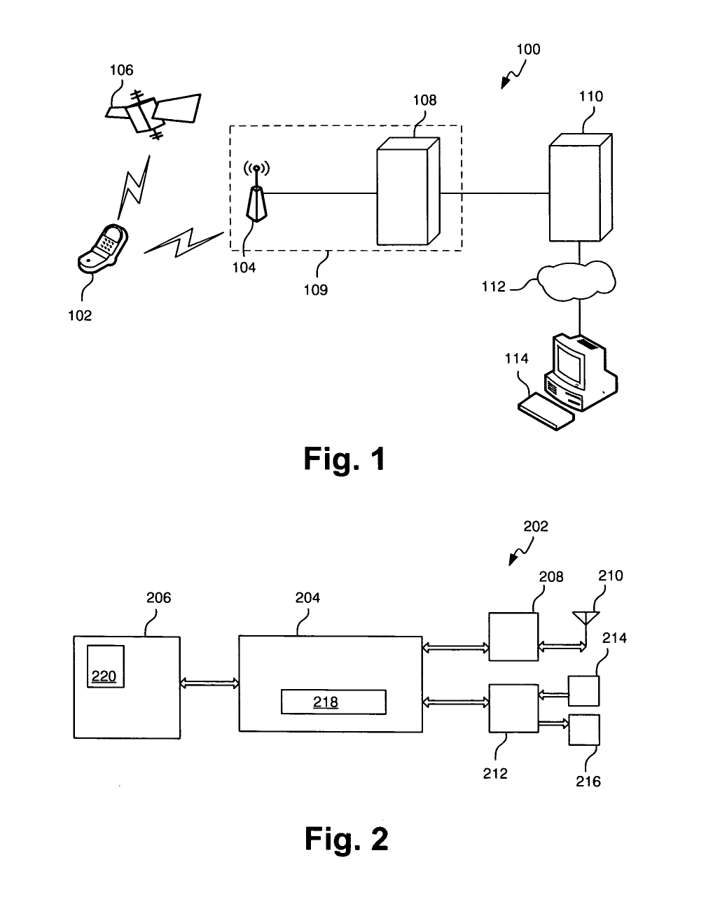

Referring first to FIG. 1, there is shown exemplary system arrangement 100 according to one embodiment of the present invention. System 100 includes at least one wireless communication device, such as mobile phone 102, capable of communicating with at least one base transceiver station (“BTS”) 104 over the radio frequency (“RF”) spectrum. BTS 104 may be one of a plurality of base transceiver stations controlled in a particular geographic region by base station controller (“BSC”) 108. In general, BSC 108 and its corresponding one or more BTS 104 are collectively referred to as “base station” 109. Thus, base station 109 provides RF communication services to mobile phone 102 within a geographic region, e.g., a cell defined in cellular network. According to certain embodiments, mobile phone 102 may further be capable of receiving global positioning system (“GPS”) signals from one or more GPS satellites 106.

Continuing with FIG. 1, system 100 further includes mobile switching center (“MSC”) 110 connected to BSC 108, i.e., base station 109. MSC 110 provides switching services and coordinates traffic between mobile users in system 100 and external networks, represented by network cloud 112. In this way, data processing device 114 coupled to network cloud 112, e.g., via a communication network such as the Internet, is able to communicate with one or more mobile phone users in system 100.

Referring next to FIG. 2, there is shown a simplified block diagram of mobile phone 202, corresponding to mobile phone 102 in FIG. 1, according to one embodiment of the invention. Mobile phone 202 comprises, among other things, processor 204 coupled to memory 206 and to transceiver 208, typically enclosed in a housing. A mobile power source (not shown), such as a battery, is coupled to and supplies power to processor 204, memory 206 and transceiver 208. Mobile phone 202 communicates information by transmitting and receiving electromagnetic (“EM”) energy in the RF band via antenna 210 coupled to transceiver 208. Mobile phone 202 further includes input/output (“I/O”) interface 212 for communicating information with a user of mobile phone 202 via one or more I/O devices, such as keypad input 214 and display device 216, for example.

Data collection structure 220 is stored in memory 206. Data collection structure 220 typically comprises an electronic address book capable of storing a plurality of entries, where each entry is capable of storing corresponding contact information. For example, each entry of address book 220 may be capable of storing a contact's name, address, phone number, fax number, and email address, among other data. According to one embodiment, an entry of address book 220 is further capable of being associated with one or more commercial promotions. For example, a field in address book 220 may be used for storing coupons or other promotions offered by an address book contact. According to another embodiment, an entry of address book 220 may further be defined as a public entry type. A public entry type may be a contact that is publicly available, such as a listing from a public telephone book, for example. According to this particular embodiment, a public entry type contact may be dynamically populated, updated and/or deleted from address book 220, based on one or more factors, such as the user's geographic location, for example. However, dynamic population and modification of address book 220 is not limited to public entry types, as discussed below. For example, a telephone number of a private contact may be modified in certain embodiments. Moreover, although the present discussion describes single address book 220, the principles of the present invention can also be applied to implementations involving multiple address books, e.g., a public address book separate from a private address book.

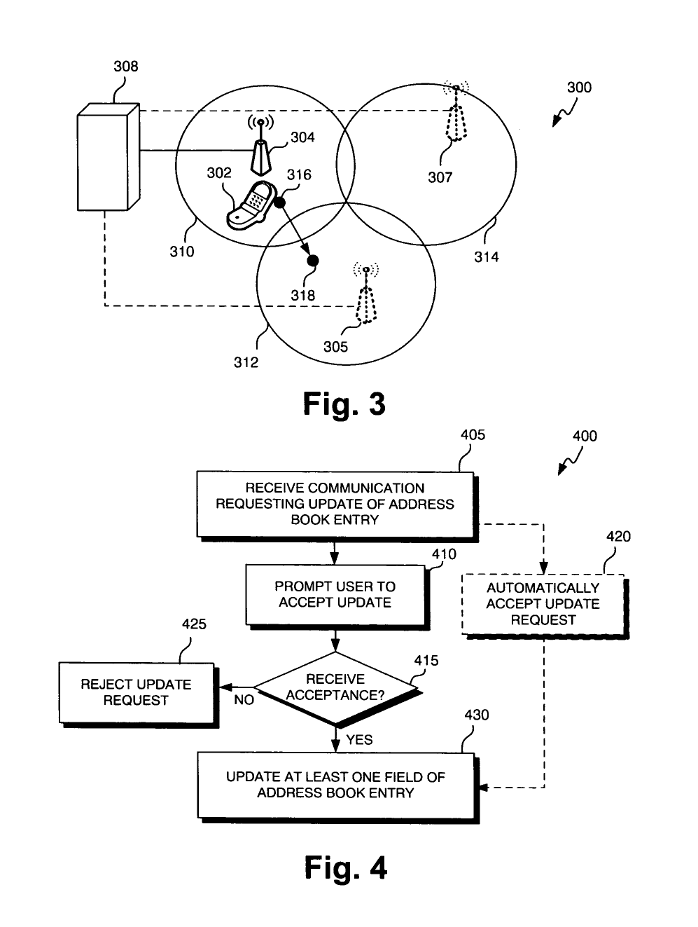

Continuing with FIG. 2, manager module 218 is executed by processor 204 for carrying out management operations. More particularly, manager module 218 carries out the operation of managing electronic address book 220 and its associated entries, as discussed below. Techniques for dynamically populating and modifying electronic address book 220 are now discussed according to various embodiments of the present invention with reference to FIGS. 3 through 4.

In FIG. 3, mobile phone 302 is depicted as operating in system environment 300, where mobile phone 302 corresponds to mobiles phones 102 and 202 of FIGS. 1 and 2, respectively. System 300 includes geographic regions 310, 312 and 314 served by BSC 308. As shown in FIG. 3, BTS 304 coupled to BSC 308 may provide coverage for each geographic region 310, 312 and 314. Alternatively, separate BTS 304, 305 and 307 may provide coverage for geographic region 310, 312 and 314, respectively. According to another embodiment (not shown), a separate base station may provide coverage for each of geographic regions 310, 312 and 314.

In the particular scenario depicted in FIG. 3, the user of mobile phone 302 is depicted as travelling from first location 316 in geographic region 310 to second location 318 in geographic region 312. For example, geographic regions 310 and 312 may be adjacent cities or may be arbitrarily defined geographic regions. A location-based service (“LBS”) may be used to track the location and/or bearing of the mobile phone 302 in system 300, such as using land-based LBS or satellite-based LBS, for example. As such, BSC 308 is able to ascertain when mobile phone 302 leaves geographic region 310 and enters geographic region 312.

Referring to FIG. 4, there is shown flow chart 400 depicting a method for dynamically populating and/or modifying a mobile phone address book according to one embodiment. Manager module 218 of FIG. 2 is typically embodied in software executable by processor 204 for carrying the method of flow chart 400 according to one embodiment. Certain details and features have been left out of flow chart 400 of FIG. 4 that are apparent to a person of ordinary skill in the art. For example, a step may consist of one or more sub-steps, as known in the art. While steps 405 through 430 shown in flow chart 400 are sufficient to describe one embodiment of the present invention, other embodiments of the invention may utilize steps different from those shown in flow chart 400.

To illustrate the exemplary method represented by flow chart 400 of FIG. 4, the scenario depicted in FIG. 3 will now be discussed. In FIG. 3, as the user travels from location 316 in geographic region 310 to location 318 in geographic region 312, it may be desirable to update entries of address book 220 associated with geographic region 312 so that address book 220 of mobile phone 302 contains current information. For example, a vendor contact may have a business presence located in a city corresponding to geographic region 318. As mobile phone 302 enters geographic region 312, the vendor's updated address book information may be communicated by BSC 308 and received by mobile phones 302 (block 405 of FIG. 4), e.g., via a data transmission. Thereafter, the user of mobile phone 302 may be prompted to accept or reject the updated address book information (block 410). The user may communicate acceptance and/or rejection by using a keypad or other input device (block 415). If the user accepts the update, the vendor's entry in address book 220 is updated with the updated address book information (block 430); otherwise, the updated address book information is rejected (block 425). In certain embodiments, the user may define a preference or setting to automatically accept updates associated with one or more contacts when updated address book information corresponding to those contacts is received by the mobile phone 302 (blocks 420 and 430). Thus, dynamic update of address book 220 of mobile phone 302 can be achieved based on the geographic location of mobile phone 302, thereby significantly improving the accuracy of address book 220 of mobile phone 302. This benefit is achieved while reducing the management burden on the user of mobile phone 302. For example, the user of mobile phone 302 need not periodically and manually ascertain and updated certain entries in address book 220 when associated contact information for those entries has been updated. Rather, according to the particular embodiment discussed above, address book 220 of mobile phone 302 can be dynamically updated for the user based on the geographic location of mobile phone 302.

According to certain embodiments, one or more entries in address book 220 may be capable of storing or otherwise being associated with a commercial promotion. For example, in addition to storing contact information, address book 220 may also be capable of storing a coupon or discount for a vendor contact in address book 220. As such, such commercial promotions can be treated as a specific type of contact information for a vendor of products and/or services, who is stored as an entry in address book 220. Thus, the commercial promotion may be received and updated in the manner described above for updated contact information. Updated commercial promotions can thus be dynamically communicated and/or updated to a user of mobile phone 102, 202 and 302. Moreover, such coupons are tied directly to specific contacts in the user's address book 220, thereby significantly reducing users' burden in managing and updating commercial promotions received from prospective vendors. Thus, outdated promotions can be dynamically updated with current promotions. Moreover, the user has the ability to reject a commercial promotion before the commercial promotion is stored on the user's mobile phone. In contrast, unsolicited SMS messages containing advertisements occupy precious storage space on the user's mobile phone without the user's permission.

According to another embodiment, address book 220 of mobile phone 302 can be dynamically updated based on events other than the change of location of the mobile phone 302. An example of another such event may be the modification, addition or deletion of at least one piece of contact information corresponding to an entry in address book 220 of mobile phone 302. System 100 may provide a database or other repository, e.g., on data processing device 114 in FIG. 1, for a vendor to record any changes in contact information. For example, if the business phone number of the vendor (discussed above) has changed, the vendor may modify a database record stored on data processing device 114 to record the modified business phone number. Various techniques for accessing and modifying contact information stored on data processing device 114 may be used, such as by way of data communication through an Internet connection between the vendor's computer and data processing device 114, for example. Moreover, since base station 109 is coupled for communication to data process device 114, base station 109 is able to ascertain changes to the vendor's contact information stored on data processing device 114. When mobile phone 102 registers with system 100, e.g., when user turns on mobile phone 102, base station 109 is able to communicate the updated contact information of the vendor to mobile phone 102 by retrieving the same from data processing device 114 via MSC 110 and network 112. As discussed above, the user may be prompted to accept or reject the updated contact information or may specify a preference to automatically accept the updated contract information. Thus, one or more entries in address book 220 can be dynamically updated according to other events. As discussed above, commercial promotions can also be dynamically updated employing address book 220.

According to another embodiment, in addition to the modification and update of entries currently stored in address book 220, new entries may be dynamically populated (added) into address book 220. With continuing reference to FIG. 3, this particular embodiment is useful when a user of mobile phone 302 is entering geographic region 312 and desires public contact information relevant to businesses within geographic region 312. For example, the user mobile phone 302 may desire to receive contact information relevant to restaurants as the user travels. Such a preference may be stored on a database (not shown) which is accessible to BSC 308 in system 300. As the user travels into geographic region 312, BSC 308 may transmit contact information of restaurants located within geographic region 312 to mobile phone 302. As discussed above, the user may be prompted to accept the addition of new address book entries, or may specify a preference to automatically populate certain new entries into address book 220.

Similarly, the user may desire to dynamically remove entries from address book 220. Referring again to FIG. 3, this particular embodiment is useful when a user of mobile phone 302 is leaving geographic region 310 and desires to remove public contact information relevant to businesses within geographic region 310 from address book 220. As discussed above, the user may be prompted to accept the deletion of address book entries, or may specify a preference to automatically delete certain entries from address book 220.

According to one embodiment, address book 220 supports public-type entries for storing public address contact information. Thus, unlike private-type entries which cannot be dynamically modified according to various techniques discussed above, public-type entries may be dynamically added, updated and/or deleted from address book 220. Private-type entries can thus be protected from modification by outside sources, e.g., BSC 108, while providing public-entries which can be modified, as discussed herein. Alternatively, separate address books, e.g., a public address book and a private address book, may be employed to distinguish public and private entries stored in mobile phone 102. According to another embodiment, no distinction is made between public and private entries. According to this particular embodiment, each entry of address book 220 may be subject to dynamic modification as discussed herein.

From the above description of exemplary embodiments of the invention, it is manifest that various techniques can be used for implementing the concepts of the present invention without departing from its scope. Moreover, while the invention has been described with specific reference to certain embodiments, a person of ordinary skill in the art would recognize that changes could be made in form and detail without departing from the spirit and the scope of the invention. The described exemplary embodiments are to be considered in all respects as illustrative and not restrictive. It should also be understood that the invention is not limited to the particular exemplary embodiments described herein, but is capable of many rearrangements, modifications, and substitutions without departing from the scope of the invention.

What is claimed is:

1. A mobile phone comprising:
a display;
an input key;
a processor coupled to the display and to the input key;
a memory coupled to the processor, the memory capable of storing a data collection structure, the data collection structure capable of storing a plurality of entries, each of the plurality of entries associated with corresponding contact information;
a manager module executed by the processor, the manager module configured to receive address book data transmitted over a wireless data communication link; and
at least one field of the plurality of entries capable of being dynamically modified based on the received address book data.

2. The mobile phone of claim 1 wherein the manager module receives the address book data based on the geographic location of the mobile phone.

3. The mobile phone of claim 1 wherein at least one of the plurality of entries is a public-type entry.

4. The mobile phone of claim 3 wherein the public-type entry is added to the data collection structure based on the geographic location of the mobile phone.

5. The mobile phone of claim 3 wherein the public-type entry is deleted from the data collection structure based on the geographic location of the mobile phone.

6. The mobile phone of claim 1 wherein at least one of the plurality of entries further capable of being associated with a commercial promotion, the address book data further including the commercial promotion.

7. The mobile phone of claim 6 wherein the commercial promotion is a coupon containing coupon data.

8. The mobile phone of claim 1 wherein the manager module stores the address book data in the memory after an acknowledgement signal is received via the input key.

9. The mobile phone of claim 1 wherein the wireless data communication link is established in the radio frequency spectrum.

10. A method for managing a data collection structure stored in a memory of a wireless communication device, the data collection structure capable of storing a plurality of entries, each of the plurality of entries associated with corresponding contact information, the method comprising:
receiving address book data transmitted over a wireless data communication link; and
dynamically modifying at least one field of the plurality of entries based on the received address book data.

11. The method of claim 10 wherein the address book data is received based on the geographic location of the wireless communication device.

12. The method of claim 10 wherein at least one of the plurality of entries is a public-type entry.

13. The method of claim 12 wherein the dynamically modifying comprises adding the public-type entry to the data collection structure based on the geographic location of the wireless communication device.

14. The method of claim 12 wherein the dynamically modifying comprises deleting the public-type entry from the data collection structure based on the geographic location of the wireless communication device.

15. The method of claim 10 wherein the address book data further comprises a commercial promotion, the dynamically modifying further comprising associating the commercial promotion with at least one of the plurality of entries.

16. The method of claim 15 wherein the commercial promotion is a coupon containing coupon data.

17. The method of claim 10 further comprising:
receiving an acknowledgement signal; and
storing the address book data in the data collection structure after the acknowledgement signal is received.

18. The method of claim 10 wherein the wireless data communication link is established in the radio frequency spectrum.

19. A data communication message capable of being transmitted over a wireless data communication link established between first and second wireless communication devices, one of the first and second wireless communication devices including a data collection structure stored in a memory, the data communication message comprising:
address book data, the address book data containing at least one data field for dynamically modifying an entry of the data collection structure.

20. The data communication message of claim 19 wherein the address book data is transmitted based on the geographic location of the one of the first and second wireless communication devices.

21. The data communication message of claim 19 the modified entry of the data collection structure is a public-type entry.

22. The data communication message of claim 21 wherein the public-type entry is added to the data collection structure based on the geographic location of the one of the first and second wireless communication devices.

23. The data communication message of claim 21 wherein the public-type entry is deleted from the data collection structure based on the geographic location of the one of the first and second wireless communication devices.

24. The data communication message of claim 19 wherein the address book data further includes a commercial promotion, the modified entry of the data collection structure further capable of being associated with the commercial promotion.

25. The data communication message of claim 24 wherein the commercial promotion is a coupon containing coupon data.

26. The data communication message of claim 19 wherein the wireless data communication link is established in the radio frequency spectrum.
